(19) United States
(12) Patent Application Publication
(10) Pub. No.: US 2010/0261141 A1
(43) Pub. Date: Oct. 14, 2010

(54) Dental Implant Device and Screw

(75) Inventors: Raed Ajlouni, Coppell, TX (US); Khaldoun Ajlouni, Coppell, TX (US); Hanan Ajlouni, Amman (JO)

Correspondence Address: BAKER BOTTS L.L.P., 2001 ROSS AVENUE, SUITE 600, DALLAS, TX, 75201-2980, US

(73) Assignee: The Texas A&M University System, College Station, TX (US)

(21) Appl. No.: 12/421,732

(22) Filed: Apr. 10, 2009

(51) Int. Cl. A61C 8/00

(52) U.S. Cl. 433/174

(57) ABSTRACT

In one embodiment of the present invention, a dental implant may include an implant fixture capable of securing the dental implant in bone. An implant neck with a non-metallic coating may surround the coronal end of the implant fixture. An implant abutment attaches to the implant fixture at the implant fixture's coronal end. A crown attaches around the implant abutment and adjacent to the neck.

### TECHNICAL FIELD

The present disclosure relates generally to the field of dental implant devices and bone screws and, more particularly, to a dental implant and a threaded bone anchor, and a universal driver for installing the same.

### BACKGROUND OF THE DISCLOSURE

Humans occasionally lose teeth due to tooth decay, root canal failure, periodontitis, trauma to the mouth, excessive wear and tear, and congenital defects. People who have lost teeth might feel too self-conscious to smile or talk. Additionally, biting irregularities caused by tooth loss can have a negative effect on eating habits, leading to secondary health problems such as malnutrition. A dental implant is an artificial tooth used in prosthetic dentistry to support restorations that resemble a tooth or a group of teeth. Dental implants serve both a medical as well as cosmetic function.

### SUMMARY OF THE DISCLOSURE

The present invention relates generally to surgical implants and dental devices. More specifically, the present invention relates to a dental implant and a threaded bone anchor, and a universal driver for installing the same.

In one embodiment of the present invention, a dental implant may include an implant fixture capable of securing the dental implant in bone. An implant neck with a non-metallic coating may surround the coronal end of the implant fixture. An implant abutment attaches to the implant fixture at the implant fixture's coronal end. A crown attaches around the implant abutment and adjacent to the neck.

Certain embodiments of the invention may provide numerous technical advantages. For example, a technical advantage of one embodiment may include the capability to provide improved aesthetics and oral health. Other technical advantages of other embodiments may include the capability to improve primary and secondary stability of the dental implant. Yet other technical advantages of other embodiments may include the capability to anchor the dental implant with a shorter and narrower anchoring device. Still yet other technical advantages of other embodiments may include the capability to install multiple components of a dental implant using a single driver device.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1A shows a top view of a human jaw illustrating commonly used terms of relationship and comparison in dentistry;

FIG. 1B shows a perspective view of a dental implant for tooth replacement illustrating commonly used terms of relationship and comparison in dentistry;

FIG. 1C shows a perspective view of a row of dental implants for tooth replacement illustrating commonly used terms of relationship and comparison in dentistry;

FIGS. 2A and 2B show illustrations of dental implants for tooth replacements installed in a human jaw;

FIG. 3 shows a cross-sectional view of a dental implant for tooth replacement according to several embodiments;

FIGS. 4A and 4B show perspective views of two dental implants for tooth replacement according to several embodiments;

FIG. 4C shows a reference coordinate system for FIGS. 4A and 4B;

FIGS. 5A and 5B show top views of two dental implants for tooth replacement according to several embodiments of the disclosed invention;

FIGS. 6A, 6B, 6C, and 6D show mesial (interproximal) cross-sectional views of various dental implants crafted to replace a molar tooth according to several embodiments;

FIG. 6E shows a facial cross-sectional view of the dental implant of FIG. 6D;

FIG. 6F shows a facial cross-sectional view of a dental implant crafted to replace an incisor or canine tooth according to several embodiments;

FIG. 6G shows an interproximal cross-sectional view of the dental implant of FIG. 6F;

FIGS. 7A and 7B show perspective views of two dental implants according to several embodiments;

FIG. 8 shows a perspective view of a threaded bone screw according to several embodiments;

FIG. 9 shows a cross-sectional perspective view of a threaded bone screw according to several embodiments;

FIGS. 10A and 10B show two top views of a single thread cross-section from a threaded bone screw according to several embodiments;

FIGS. 10C and 10D show two top views of a single thread cross-section from a threaded bone screw according to several embodiments;

FIGS. 11A, 11B, and 11C show three cross-sectional elevation views of two threads from a threaded bone screw according to several embodiments;

FIG. 12A shows a top view of a single thread cross-section from a threaded bone screw according to several embodiments;

FIG. 12B shows a perspective view of the single thread cross-section presented in FIG. 12A;

FIG. 13 shows a top view of a single thread cross-section from a threaded bone screw according to several embodiments;

FIGS. 14A and 14B shows two perspective views of two threaded bone screw according to several embodiments;

FIGS. 15A, 15B, and 15C show three top views of a single thread cross section from a threaded bone screw according to several embodiments of the disclosed invention;

FIG. 16A shows a perspective view of a threaded bone screw according to several embodiments of the disclosed invention;

FIG. 16B shows a top view of a single thread cross section from the threaded bone screw presented in FIG. 16A;

FIG. 17 shows a perspective view of a threaded bone screw according to several embodiments;

FIG. 18 shows a threaded bone screw with oblique threads according to several embodiments;

FIG. 19 shows a perspective view of a threaded bone screw incorporate elements from multiple embodiments; and

FIG. 20 shows a universal implant driver according to one embodiment.

### DETAILED DESCRIPTION OF EXAMPLE EMBODIMENTS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

### Implant Neck

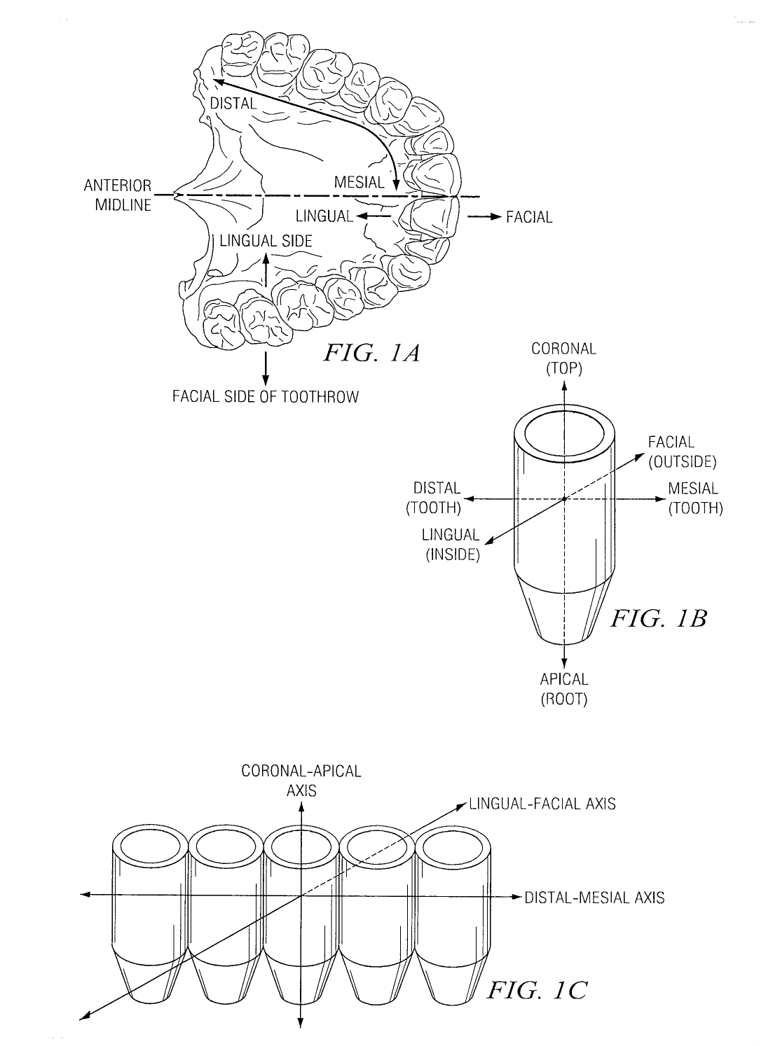

FIG. 1A shows a top view of a human jaw illustrating commonly used terms of relationship and comparison in dentistry. FIG. 1A illustrates two directional axes in a human mouth: the distal-mesial axis and the lingual-facial axis. The distal and mesial surfaces are “proximal” surfaces, and the space between the mesial surface of one tooth and the distal surface of the next tooth is the “interproximal” space. Distal refers to the direction towards the last tooth in each quadrant of a dental arch. Mesial refers to the direction towards the anterior midline. Lingual refers to the side of a tooth adjacent to (or the direction towards) the tongue. Facial refers to the side of a tooth adjacent to (or the direction towards) the inside of the cheek or lips.

FIG. 1B shows a perspective view of a dental implant for tooth replacement illustrating commonly used terms of relationship and comparison in dentistry. FIG. 1B illustrates three directional axes in a human mouth: the distal-mesial axis, the lingual-facial axis, and the coronal-apical axis. Coronal refers to the direction towards the crown of a tooth. Apical refers to the direction towards the root tip(s) of a tooth. FIG. 1C shows a perspective view of a row of dental implants for tooth replacement illustrating the distal-mesial axis, the lingual-facial axis, and the coronal-apical axis.

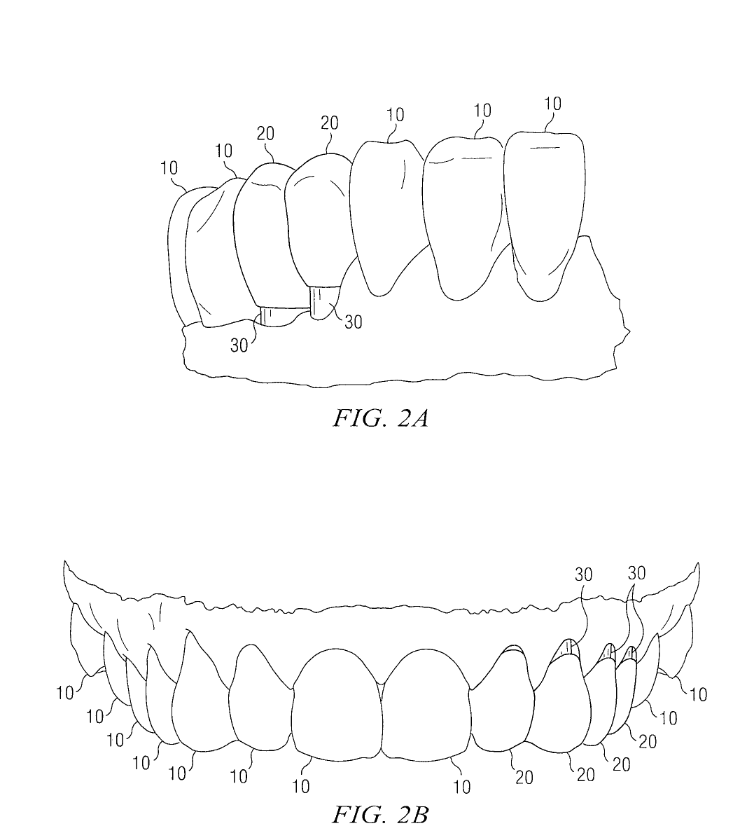

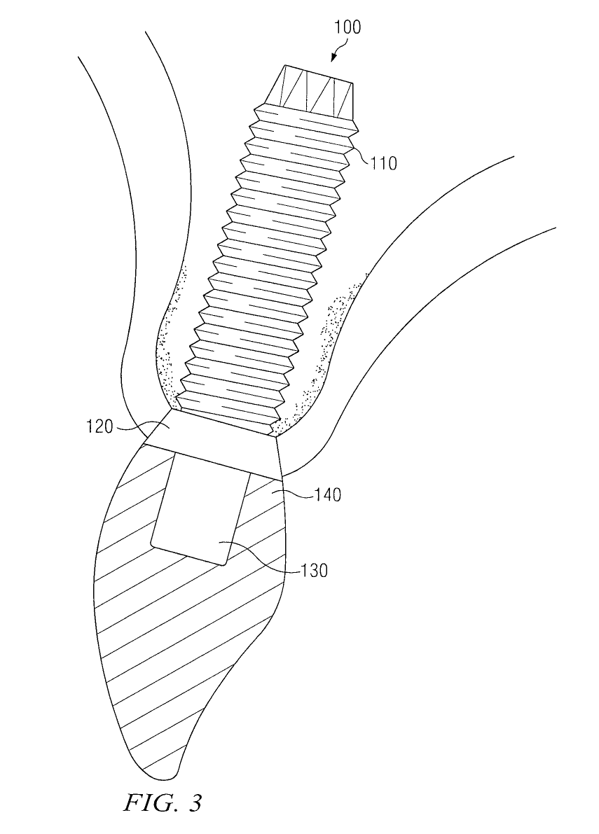

FIGS. 2A and 2B show illustrations of dental implants for tooth replacements installed in a human jaw. FIGS. 2A and 2B depict a human mouth with both “real” teeth 10 and replacement dental implants 20. In FIGS. 2A and 2B, unsightly dark metal 30 is exposed at the neck of the dental implants 20. This phenomena may have several causes. For example, the surgeon or periodontist installing the implant may not be able to place the implant deep within the gingiva due to limitations in bone height. Also, placing the implant deep within the tissues or submerging the implant can be a complicated and unpredictable procedure. Additionally, the gingiva may recede or thin-out after the implant is installed, revealing the dark metal underneath. Furthermore, rough metal surfaces near the gingiva can cause bacterial accumulation, inflammation, and bone resorption.

Accordingly, teachings of certain embodiments recognize the use of an implant neck to cover a portion of the unsightly dark metal and improve oral health. Additionally, teachings of certain embodiments recognize that an implant neck can reduce or eliminate the need for soft-tissue augmentation and grafting after implant placement.

FIG. 3 shows a cross-sectional view of a dental implant for tooth replacement according to several embodiments. The dental implant 100 in FIG. 3 features an implant fixture 110, an implant neck 120, an implant abutment 130, and a crown 140.

Implant fixture 110 may include any device operable to anchor the dental implant 100 into the bone. For example, in several embodiments of dental implant 100, implant fixture 110 may be a threaded medical screw. In several embodiments of dental implant 100, implant fixture 110 may be made of metal, such as titanium alloy. Other embodiments of dental implant 100 may utilize other shapes and materials for implant fixture 110.

Implant neck 120 covers an upper portion of implant fixture 110. Embodiments of neck 120 may be made out of any suitable materials. For example, in one embodiment, the implant neck 120 may be ceramic. Materials such as ceramic may provide a smooth, aesthetically-pleasing surface while hiding the upper portion of implant fixture 110. In certain embodiments, some or all of the neck 120 may be made of other materials, including metal. Thus, other embodiments of dental implant 100 may include some, different, or additional features those described herein.

In several embodiments, the height of the implant neck 120 may be sized to fit between the top of the alveolar bone and the top of the surrounding gingiva in a tooth socket. In some embodiments, this height may fall in the range of 1.0 millimeter to 3.0 millimeters. However, other embodiments of the neck 120 are not limited to fitting between the top of the alveolar bone and the top of the surrounding gingiva. In yet other embodiments, the height of the implant neck 120 may depend on other preexisting conditions in the mouth. In yet other embodiments, the height and thickness of the implant neck 120 may be sized to match the shape of the crown 140. In several embodiments, the implant neck 120 may be crafted to reflect the natural curvature of a tooth.

The implant neck 120 may be the result of various manufacturing methods. For example, the implant neck 120 may be formed by processes such as solid casting, layering, injection molding, heat treating, or other available processing techniques. In several embodiments, the implant neck 120 may be crafted to fit over an existing implant fixture 110. In some embodiments, the implant neck 120 may be a ceramic coating that is applied over the implant fixture 110, the abutment 130, or another component of the dental implant for tooth replacement.

The implant abutment 130 may attach to implant the fixture 110. In some embodiments, the implant abutment 130 may be made of metal, such as titanium alloy. The implant abutment 130 may also fit inside of the implant neck 120. In several embodiments of the dental implant 100, the implant abutment 130 will be in complete contact with an internal connection of the implant fixture 110 at all times so as to avoid exerting any direct pressure on the implant neck 120 and prevent fracture or chipping of the implant neck 120.

The crown 140 attaches to the implant abutment 130. The crown 140 may resemble a human tooth. In several embodiments, the crown 140 will be flush with the implant neck 120. In other embodiments, a gap between the implant neck 120 and the crown 140 will protect the implant neck 120 against pressure and damage. For example, in several embodiments, the implant neck 120 and the crown 140 are 5-10 micrometers apart.

As stated above, the implant neck 120 provides several aesthetic benefits. However, where the implant neck 120 is hidden from view, stability and osseointegration may be more important than aesthetic concerns. Accordingly, teachings of certain embodiments recognize the use of an implant neck 120 that both minimizes non-metallic coverage while maximizing aesthetic affect. Additionally, teachings of certain embodiments recognize that reducing implant neck 120 in places where aesthetics are not as important may increase osseointegration between the bone and implant fixture 110. Furthermore, teachings of certain embodiments recognize that decreasing the height of the implant neck between adjacent teeth may preserve interdental bone height and improve gingival aesthetics.

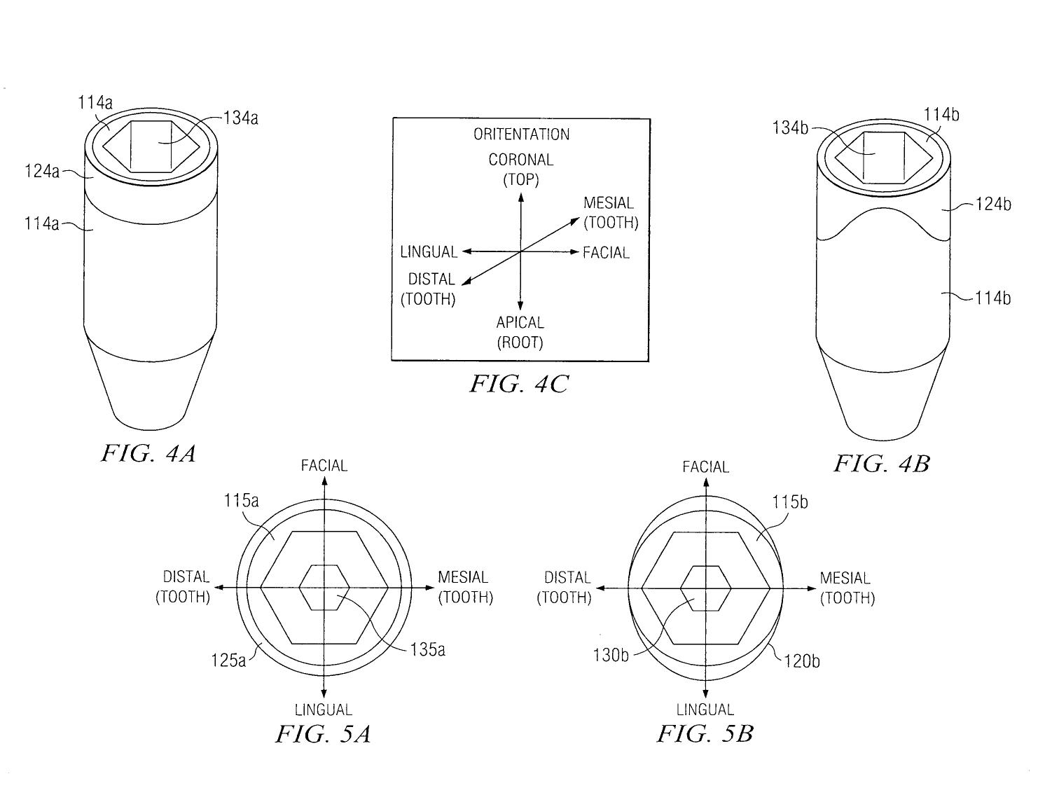

FIGS. 4A and 4B show perspective views of two dental implants for tooth replacement according to several embodiments. FIG. 4C shows a reference coordinate system for FIGS. 4A and 4B. FIG. 4A features an implant fixture 114a, an implant neck 124a, and an implant abutment 134a. FIG. 4B features an implant fixture 114b, an implant next 124b, and an implant abutment 134b.

In FIG. 4A, the implant neck 124a maintains a equal height in all directions. In FIG. 4B, the implant neck 124b is scalloped: the neck 124b is taller in the facial and lingual directions and shorter in the mesial and distal directions. Other embodiments of the an implant neck may take alternative shapes and geometries. In some embodiments, the implant fixture may be formed to match the shape of the implant neck.

FIGS. 5A and 5B show top views of two dental implants for tooth replacement according to several embodiments. FIG. 5A features an implant fixture 115a, an implant neck 125a, and an implant abutment 135a. FIG. 5B features an implant fixture 115b, an implant neck 125b, and an implant abutment 135b.

In FIG. 5A, the implant neck 125a maintains a equal thickness in all directions. In FIG. 5B, the implant neck 125b is scalloped: implant neck 125b is thicker in the facial and/or lingual directions and thinner in the mesial and/or distal directions. Other embodiments of an implant neck may take alternative shapes and geometries. Embodiments of an implant neck may be formed to match the shape of the crown.

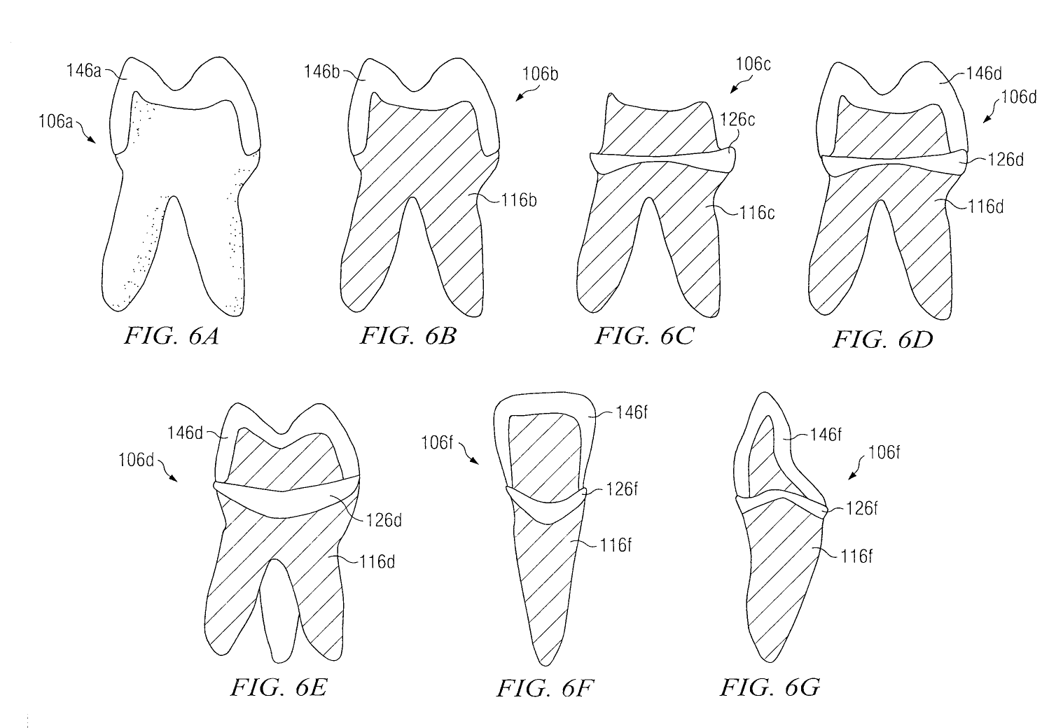

Embodiments of the dental implant may be crafted into any shape. For example, the design of the dental implant may depend on the shape of the receiving tooth socket. FIGS. 6A, 6B, 6C, and 6D show mesial (interproximal) cross-sectional views of various forms of a dental implant crafted to replace molar tooth according to several embodiments. FIG. 6A shows a molar tooth 106a with a replacement crown 146a. FIG. 6B shows a dental implant 106b with an implant fixture 116b and a crown 146b crafted to replace a molar tooth. FIG. 6C shows a dental implant 106c with an implant fixture 116c and a neck 126c crafted to replace a molar tooth. FIG. 6D illustrates a dental implant 106d with an implant fixture 116d, a neck 126d, and a crown 146d crafted to replace a molar tooth. FIG. 6E shows a facial cross-sectional view of the dental implant 106d of FIG. 6D, featuring the implant fixture 116d, the neck 126d, and the crown 146d.

Embodiments are not limited to molar teeth. Rather, embodiments of a dental implant may be crafted to replace any tooth. For example, FIG. 6F shows a facial cross-sectional view of a dental implant 106f with an implant fixture 116f, a neck 126f, and a crown 146f crafted to replace an incisor or canine tooth. FIG. 6G shows an interproximal cross-sectional view of the dental implant 106f of FIG. 6F, featuring the implant fixture 116f, the neck 126f, and the crown 146f.

The embodiments illustrated in FIGS. 6A-6G may also include elements featured in other available embodiments. For example, embodiments of the dental implant illustrated in FIGS. 6A-6G may feature an implant abutment 130, such as the implant abutment 130 illustrated in FIG. 3.

Referring back to FIG. 3, embodiments of the implant abutment 130 may attach to the implant fixture 110 in various ways. However, existing methods of attaching the abutment 130 to the implant fixture 110 may not adequately stabilize abutment 130. For example, the abutment 130 may be attached to the implant fixture 110 using one or more screws. However, these screws may be unstable or break, causing the implant abutment 130 to become unstable or dislodge. Accordingly, teachings of certain embodiments recognize the use of an internal connection mechanism to stabilize the implant abutment and reduce the functional pressure on the abutment-fixture connection.

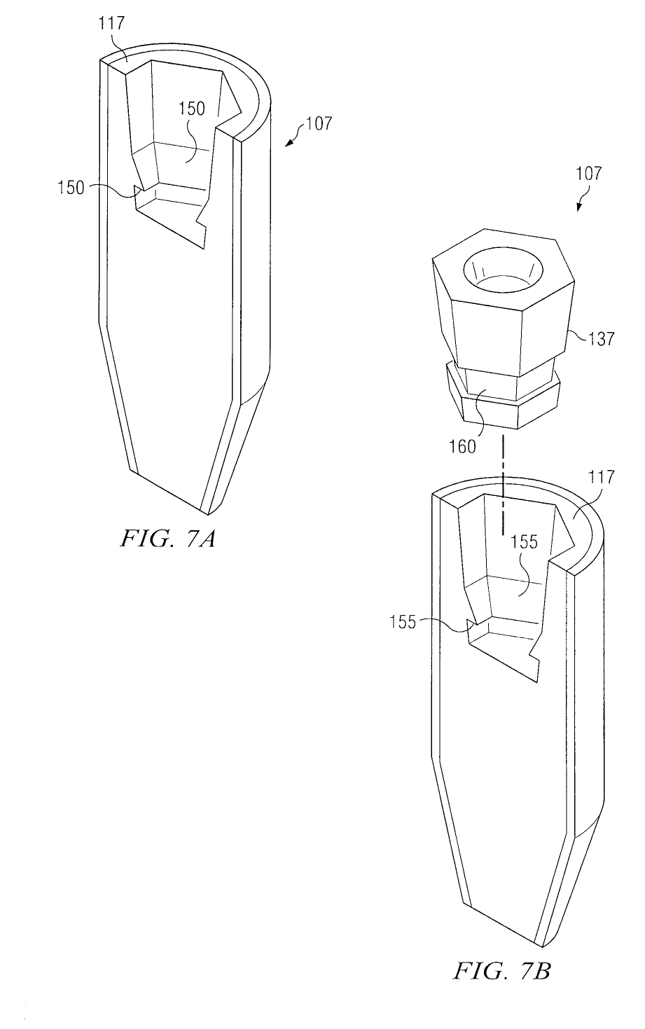

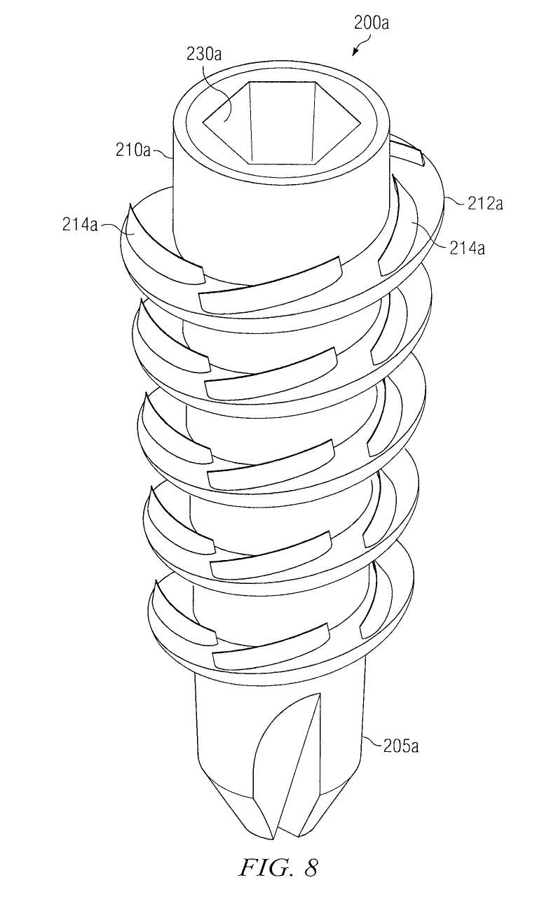

FIG. 7A shows a cross-sectional perspective view of a dental implant 107 for tooth replacement according to several embodiments. Dental implant 107 features an implant fixture 117 and an implant abutment 137. The cross-section portion of FIG. 7A also reveals an internal connection mechanism 150 according to several embodiments. The internal connection mechanism 150 helps secure the implant abutment 137 to the implant fixture 117. Embodiments may include any available means for securing implant abutment 137 to the implant fixture 117.

For example, FIG. 7B shows one example of an internal connection mechanism 150 according to several embodiments. In the illustrated embodiment, an internal ridge 155 extends circumferentially from the inside surface of implant fixture 117 and corresponds to similarly-sized internal groove 160 on the outside surface of abutment 137. In alternative embodiments, the internal connection mechanism 150 may comprise a plurality of internal ridges 155 that extend circumferentially from the inside surface of implant fixture 117 and correspond to similarly-sized internal grooves 160 on the outside surface of abutment 137. According to this embodiment, when the abutment 137 is secured inside implant fixture 117, the internal ridge 155 will be forced inside the internal groove 160 and create additional retention of abutment 137.

In some embodiments, the dental implants may be manufactured in several pieces. For example, in one embodiment, the fixture, abutment, neck, and crown may all be individual components. However, in other embodiments, two or more of these components may be incorporated into a single component. For example, in one embodiment, the neck and crown may be incorporated into a single ceramic component.

### Threaded Implant Fixtures

FIGS. 4A-4B, 6A-6G, and 7A-7B illustrate embodiments of implant fixtures, each with a relatively smooth outer surface. However, other embodiments may feature a variety of available surfaces. For example, many embodiments may feature a threaded surface, allowing the dental implant to torque into the surrounding bone. However, some available bone screws may not provide proper primary or secondary stability.

Accordingly, teachings of certain embodiments recognize the use of ridges, grooves, and depressions to increase the surface area of the thread, improve osseointegration, and reduce implant fixture volume. Additionally, teachings of certain embodiments recognize that through the use of ridges, a bone screw can improve stability by pulling bone towards the implant fixture. Teachings of certain embodiments also recognize that through the use of depressions, a bone screw can reduce the pressure on the bone and reduce bone necrosis. Furthermore, teachings of certain embodiments recognize that grooves can act as escape channels for the bony fragments that result from the drilling and insertion process.

FIG. 8 shows a perspective view of a threaded bone screw according to several embodiments. FIG. 8 shows a screw 200a for anchoring an object into bone, featuring a center cylindrical shank 210a, a thread 212a wrapped around the center cylindrical shank 210a, and ridges 214a. The particular embodiment illustrated in FIG. 8 also features a self drilling/tapping end 205a and an internal metal connection to abutment 230a. Other embodiments of screw 200a may contain none, some, or all of the above listed features.

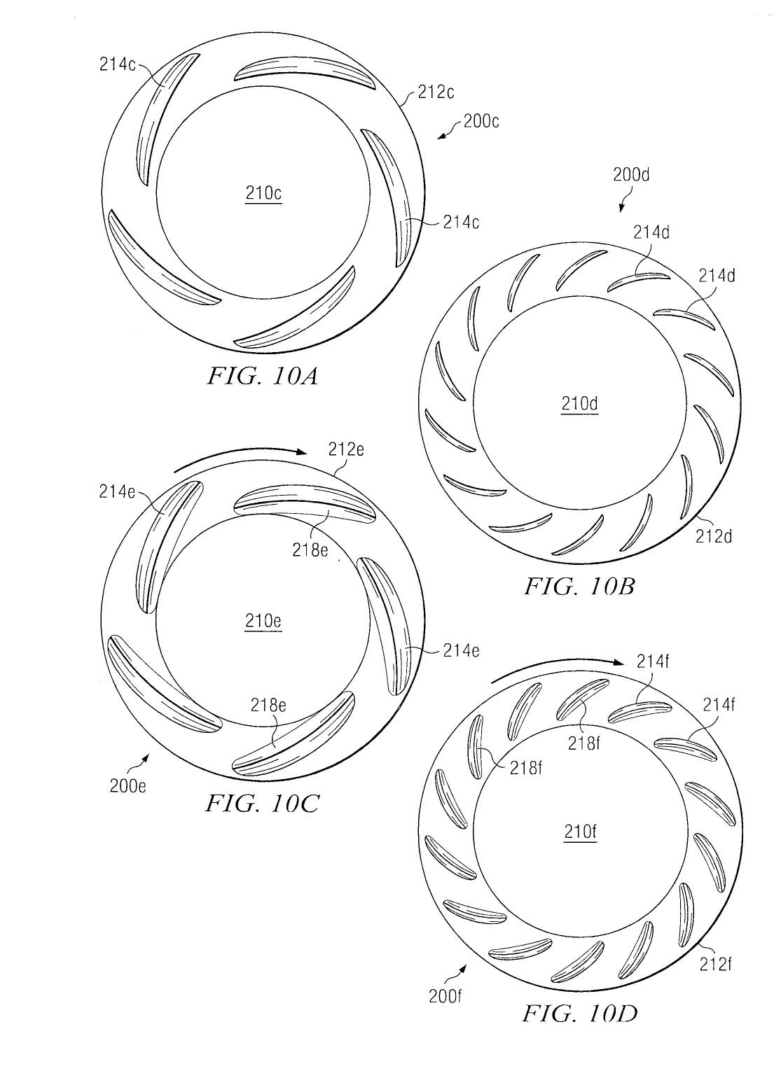

Ridges 214a may be formed on the surface of the thread 212a and extend outwards from the surface of the thread 212a. For example, embodiments of ridges 214a may include any configurations capable of pulling bone and bone fragments closer to center cylindrical shank 210a. Embodiments of ridges 214a may also include ridges 214a capable of increasing the total surface area of the screw 200a for increasing osseointegration. Additional example embodiments of ridges 214a are illustrated in FIGS. 10A-13.

In some embodiments, cylindrical shank 210a and thread 212a may feature smooth surfaces. However, in other embodiments, cylindrical shank 210a and thread 212a may feature a roughened surface area. For example, cylindrical shank 210a and thread 212a may be roughed by processes such as mechanical, chemical, or laser microetching.

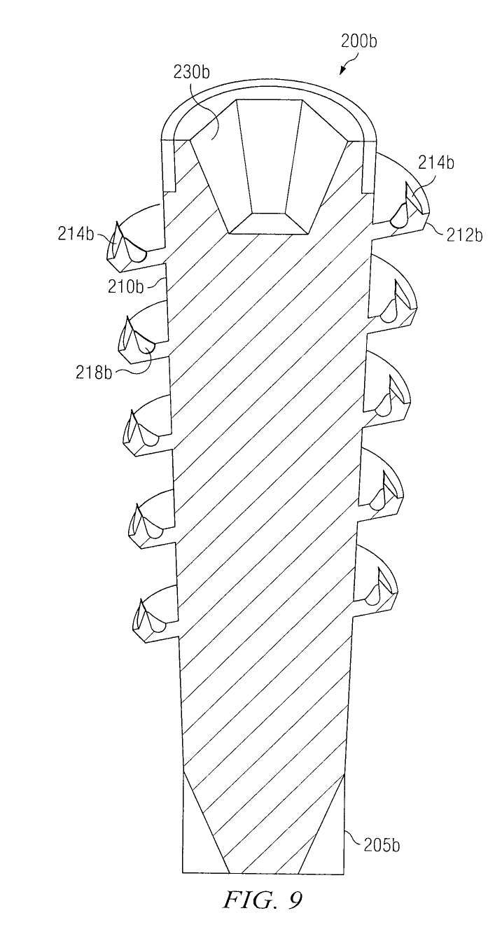

FIG. 9 shows a cross-sectional perspective view of a threaded bone screw according to several embodiments. FIG. 9 features a screw 200b with a self drilling/tapping end 205b, a center cylindrical shank 210b, a thread 212b, ridges 214b, and an internal metal connection to abutment 230b. FIG. 9 also includes depressions 218b associated with ridges 214b. Embodiments of depressions 218b may include any indentations into thread 212b. Embodiments of depressions 218b may include any configurations capable of increasing the total surface area of the screw 200b for increasing osseointegration. Embodiments of depressions 218b may also include any configurations capable of increasing the stability of the implant, reducing pressure on the bone, and reducing the bone necrosis. Embodiments of depressions 218b may be in a similar shape and size to ridges 214b but inversed into the thread. Embodiments of depressions 218b may also be a portion of the size of the ridge (e.g., 50% of the ridge volume). Additional example embodiments of ridges 214b and depressions 218b are illustrated in FIGS. 10C and 10D.

In FIGS. 8 and 9, ridges 214a/214b and depressions 218b are featured on the surface of the threads 212a/212b. However, in other embodiments, ridges and depressions may be featured on the surface of the shank 210.

FIGS. 10A and 10B shows two top views of a single thread cross section from a threaded bone screw according to several embodiments. FIG. 10A shows a screw 200c featuring a cylindrical shank 210c, a thread 212c wrapped around the center cylindrical shank 210c, and ridges 214c. FIG. 10B shows a screw 200d featuring a cylindrical shank 210d, a thread 212d wrapped around the center cylindrical shank 210c, and ridges 214d. FIGS. 10A and 10B illustrate that a bone screw may include any number of ridges according to multiple embodiments. For example, in FIG. 10A, thread 212c features five ridges 214c. In FIG. 10B, thread 212d features fourteen ridges 214d.

FIGS. 10C and 10D show two top views of a single thread cross section from a threaded bone screw according to several embodiments. FIG. 10C shows a screw 200e featuring a cylindrical shank 210e, a thread 212e wrapped around the center cylindrical shank 210e, and ridges 214e. FIG. 10D shows a screw 200f featuring a cylindrical shank 210f, a thread 212d wrapped around the center cylindrical shank 210f, and ridges 214f. FIGS. 10C and 10D resemble FIGS. 10A and 10B but include additional depressions 218e and 218f associated with ridges 214e and 214f.

In the embodiments shown in FIGS. 10C and 10D, threads 212e and 212f are intended to turn clockwise. However, other embodiments of threads 212e and 212f may turn counter-clockwise. In the embodiments illustrated in FIGS. 10C and 10D, ridges 214e and 214f pull bone and bone fragments in towards center cylindrical shanks 210e and 210f. Thus, in FIGS. 10C and 10D, ridges 214e and 214f have a front face and a rear face relative to the direction they are turning. In this particular embodiment, the front face of ridges 214e and 214f are designed to pull bone towards center cylindrical shanks 210e and 210f. In FIGS. 10C and 10D, depressions 218e and 218f appear near the front face of ridges 214e and 214f relative to the center cylindrical shanks 210e and 210f. However, in other embodiments, depressions 218e and 218f may appear elsewhere on the thread surface.

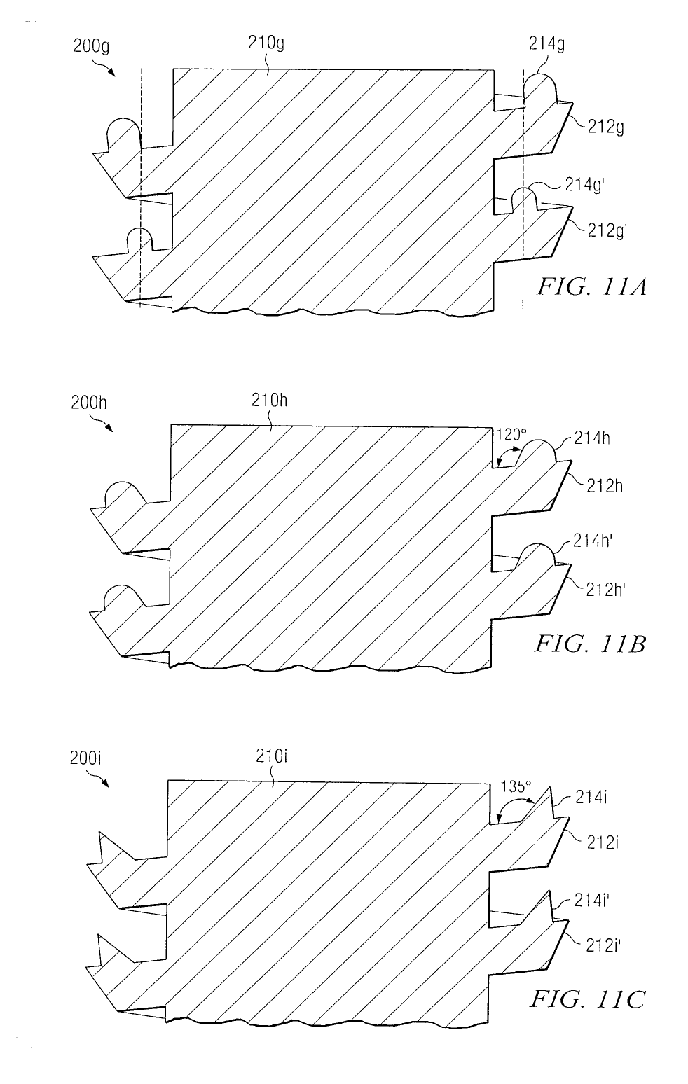

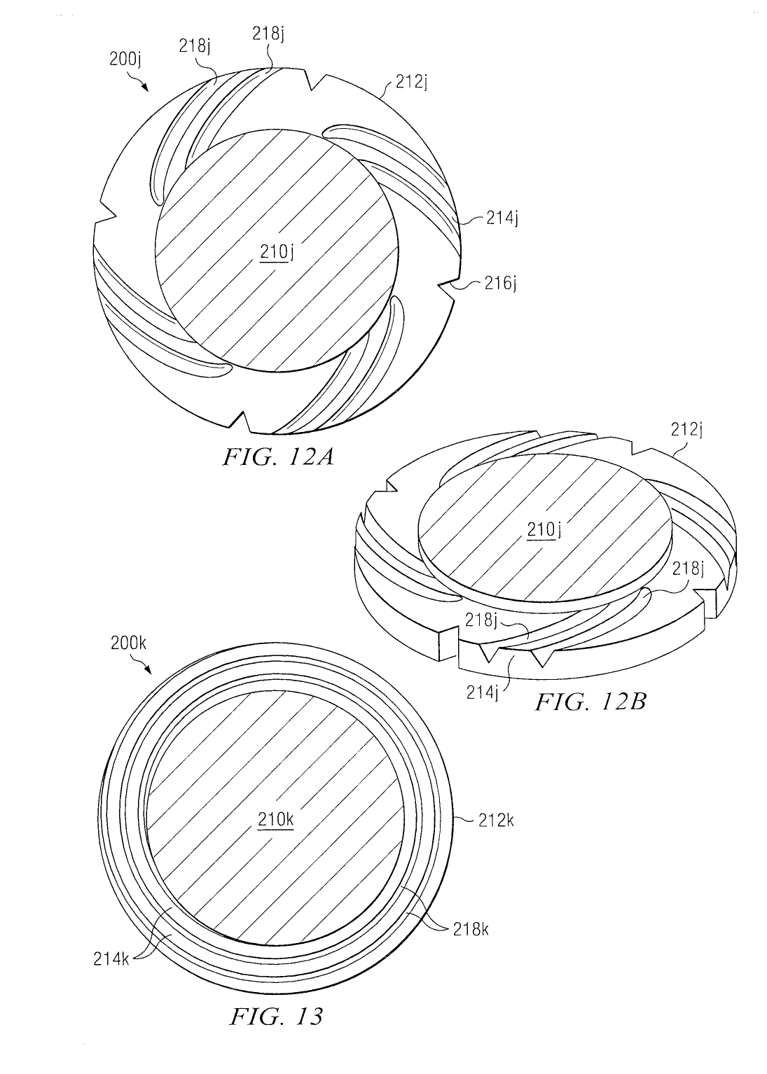

FIGS. 11A, 11B, and 11C show three cross-section elevation views of three threads from three bone screws according to several embodiments. FIG. 11A shows a screw 200g featuring a cylindrical shank 210g, threads 212g and 212g′ wrapped around the center cylindrical shank 210g, and ridges 214g and 214g′. FIG. 11B shows a screw 200h featuring a cylindrical shank 210h, a threads 212h and 212h′ wrapped around the center cylindrical shank 210h, and ridges 214h and 214h′. FIG. 11C shows a screw 200i featuring a cylindrical shank 210i, a threads 212i and 212i′ wrapped around the center cylindrical shank 210i, and ridges 214i and 214i′.

In FIG. 11A, ridges 214g and 214g′ are rounded, U-shaped protrusions out of threads 212g and 212g′. The ridges 214g on thread 212g are larger and further from center cylindrical shank 210g than the ridges 214g′ on thread 212g′. In several embodiments, ridges 214g may become smaller and/or move closer to the center cylindrical shank 210g as the thread 212g moves from the drilling end to the screw tip. In other embodiments, ridges 214g may become larger and/or move further from the center cylindrical shank 210g. In yet other embodiments, ridges 214g may retain the same position and volume.

In FIG. 11A, ridges 214g and 214g′ are perpendicular to the surface of threads 212g and 212g′. However, in other embodiments, ridges may be oriented at an alternative angle. For example, in FIG. 11B, ridges 214h and 214h′ are tilted away from the center cylindrical shank 120h degrees relative to the thread surface. Other embodiments may orient the ridges at other various angles both towards and away from the center cylindrical shank. For example, several embodiments may orient the ridges in a manner to push bone and bone fragments towards the center cylindrical shank or in a manner to reduce machining costs.

FIGS. 11A and 11B featured rounded ridges 214g, 214g′, 214h, and 214h′. However, ridges are not limited to any particular geometry. For example, FIG. 11C shows an embodiment featuring triangular ridges 214i and 214i′. In FIG. 11C, ridges 214i and 214i′ are oriented away from the center cylindrical shape at 135 degrees relative to the thread surface. Other embodiments may include ridges of different geometries oriented at different angles relative to the thread surface.

FIG. 12A shows a top view of a single thread cross section from a threaded bone screw according to several embodiments. FIG. 12A features a screw 200j with a center cylindrical shank 210j, thread 212j, ridges 214j, grooves 216j, and depressions 218j. In FIG. 12A, two depressions 218j create a ridge 214j between them. Certain embodiments may use more than two depressions 218j to create additional ridges 214j. Available embodiments include both parallel and non-parallel depressions 218j.

FIG. 12B shows a perspective view of the single thread cross section presented in FIG. 12A. FIG. 12B illustrates that, in some embodiments, ridges 214j may be flush with the surface of thread 212j, as illustrated in FIG. 12B. Teachings of embodiments such as FIG. 12A 12B recognize that creating ridges 214j out of two or more depressions 218j may reduce machining costs.

FIG. 13 shows a top view of a single thread cross section from a threaded bone screw according to several embodiments. FIG. 13 features a screw 200k with a center cylindrical shank 210k, thread 212k, ridges 214k, and depressions 218k. In FIG. 13, depressions 218k spiral around thread 212 and create spiraled ridges 214k. Teachings of certain embodiments recognize that spiraled ridges 214k and spiraled depressions 218k may move bone and bone fragments from the outside edge of thread 212k towards center cylindrical shank 210k.

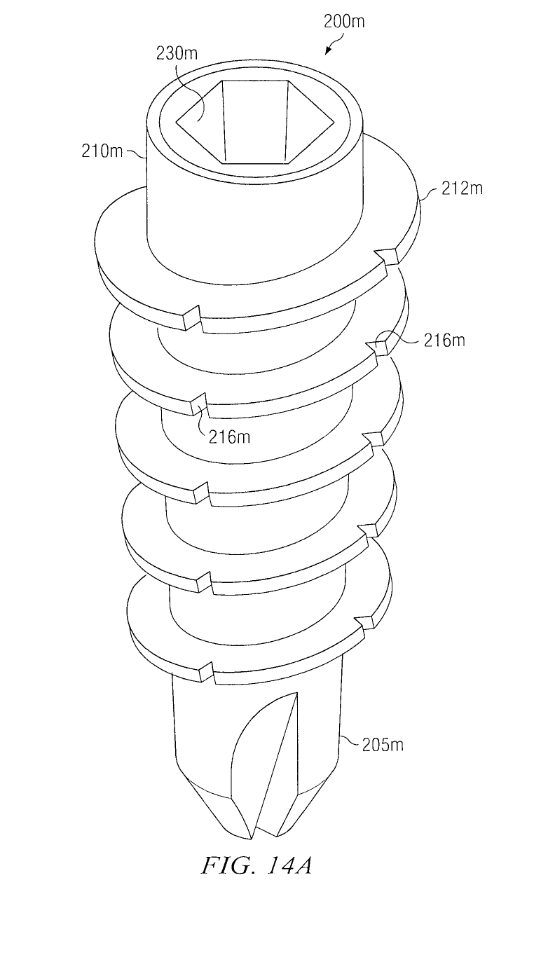

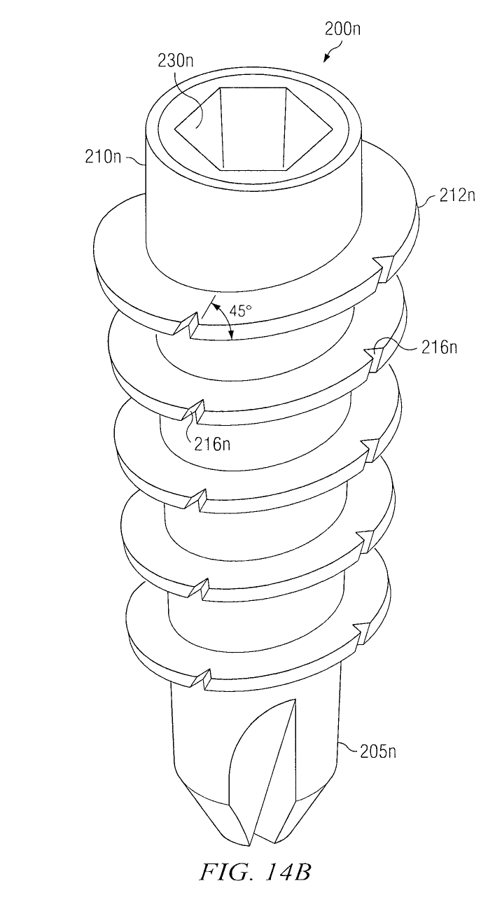

FIGS. 14A and 14B show two perspective views of two threaded bone screws according to several embodiments. FIG. 14A features a screw 200m with a center cylindrical shank 210m, thread 212m, and grooves 216m cut into the outside edge of thread 212m. FIG. 14B features a screw 200n with a center cylindrical shank 210n, thread 212n, and grooves 216n cut into the outside edge of thread 212n. In FIG. 14A, grooves 216m are cut at a 90 degree angle relative to the surface of thread 212m. In FIG. 14B, grooves 216n are cut at a 45 degree angle relative to the surface of thread 212n. However, embodiments of grooves such as grooves 216m and 216n are not limited to any particular angle.

Embodiments are not limited to any particular number of grooves. Furthermore, the number of grooves may change depending on other design characteristics. For example, some embodiments may be configured to install in a particular socket in an individual's mouth, and the number of grooves may reflect individual design restraints.

A groove such as 216m or 216n may operate individually or may operate as part of a pattern with other grooves. For example, in several embodiments, grooves may be directed to move the bony fragments towards the cylindrical shank. In several embodiments, grooves may be oriented to accumulate bone near the cylindrical shank. In yet other embodiments, grooves may be oriented so as to reduce pressure on the center cylindrical shank and reduce bone necrosis.

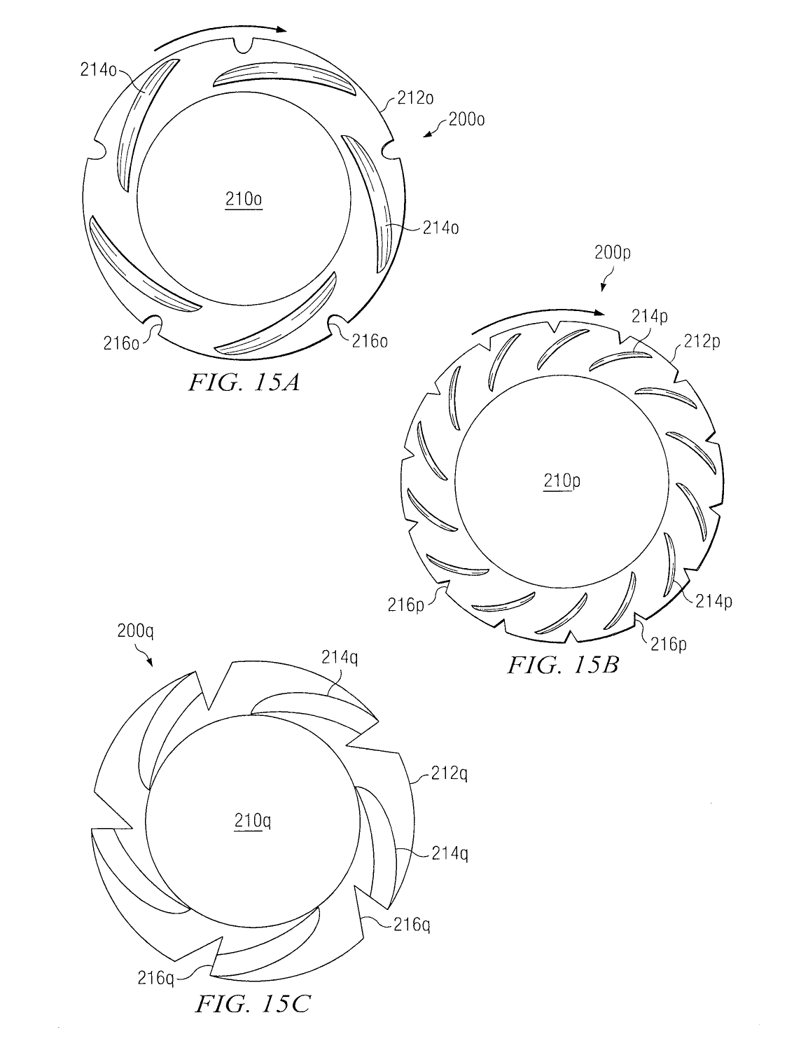

FIGS. 15A, 15B and 15C show three top views of a single-thread cross section from three threaded bone screw according to several embodiments. FIG. 15A features a screw 200o with a center cylindrical shank 210o, thread 212o, ridges 214o, and grooves 216o cut into the outside edge of thread 212o. FIG. 15B features a screw 200p with a center cylindrical shank 210p, thread 212p, ridges 214p, and grooves 216p cut into the outside edge of thread 212p. FIG. 15C features a screw 200q with a center cylindrical shank 210q, thread 212q, ridges 214q, and grooves 216q cut into the outside edge of thread 212q.

FIGS. 15A and 15B illustrate two sample geometries available for grooves 216o and 216p. FIG. 15A features curved, U-shaped grooves 216o cut into thread 212o. FIG. 15B features sharpened, V-shaped grooves 216p cut into thread 212p. However, embodiments of the grooves are not limited to any particular geometry.

In the embodiments illustrated in FIGS. 15A, 15B, and 15C, threads 212o, 212p, and 212q are intended to turn clockwise. However, other embodiments of thread 212o, 212p, and 212q may turn counter-clockwise. In the embodiments illustrated in FIGS. 15A, 15B, and 15C, ridges 214o, 214p, and 214q pull bone and bone fragments in towards the cylindrical shank. Thus, in FIGS. 15A, 15B, and 15C, ridges 214o, 214p, and 214q have a front face and a rear face relative to the direction they are turning. In this particular embodiment, the open face of ridges 214o, 214p, and 214q are designed to pull bone towards the cylindrical shank.

In FIGS. 15A and 15B, grooves 216o and 216p are located near the rear faces of ridges 214o and 214p. However, grooves are not limited to any particular placement on the thread relative to the ridges. For example, FIG. 15C illustrates an embodiment featuring grooves 216q positioned near the front face of ridges 214q. Other embodiments may include grooves located at different positions on the thread. For example, some embodiments may not have a one-to-one correlation of ridges to grooves. In some embodiments, ridges may outnumber grooves; in other embodiments, grooves may outnumber ridges.

In the embodiments illustrated in FIGS. 15A, 15B, and 15C, the grooves 216 are partially cut into the threads 212. However, in other embodiments, the grooves 216 may be cut into the threads 212 such that the grooves touch the shaft 210.

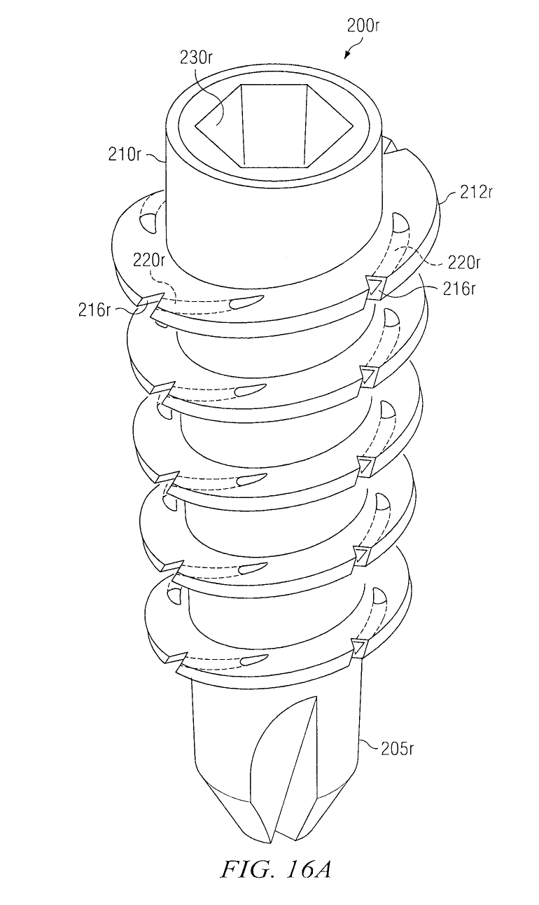

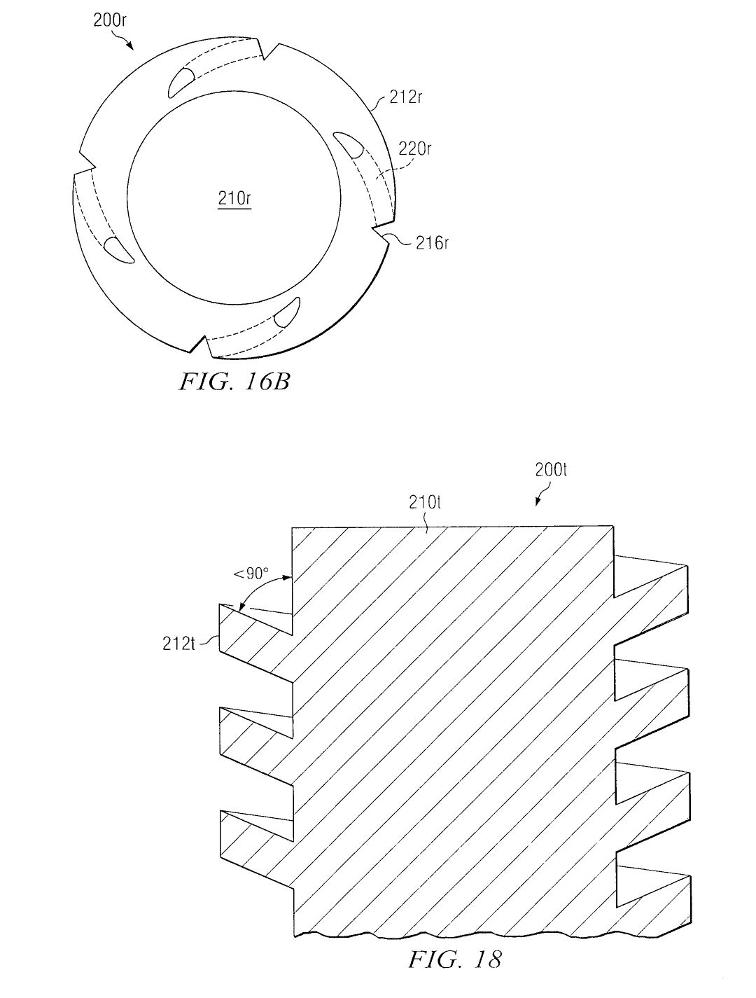

FIG. 16A shows a perspective view of a threaded bone screw according to several embodiments. FIG. 16A features a screw 200r with a self drilling/tapping end 205r, a cylindrical shank 210r, a thread 212r, grooves 216r, side-to-surface grooves 220r, and internal metal connection to abutment 230r. Side-to-surface grooves 220r connect with oblique grooves 216r and move through thread 212 to the top surface of thread 212r. Teachings of certain embodiments such as FIG. 16A recognize that side-to-surface grooves may increase the movement of bone and bone fragments from the edge of thread 212r towards center cylindrical shank 210r.

In the embodiment illustrated in FIG. 16A, the side-to-surface grooves 220r move directly from the grooves 216r through to the top surface 210r. However, in some embodiments, the side-to-surface grooves 220r may move in an indirect path, such as along the edge of the thread 210r before moving in towards the top surface 210r.

FIG. 16B shows a top view of a single thread cross section from the threaded bone screw presented in FIG. 16A. In FIG. 16B, side-to-surface grooves 220r extend from oblique grooves 216r to the top surface of thread 212r. In FIG. 16B, side-to-surface grooves 220r tunnel through the body of thread 212r. However, in other embodiments, side-to-surface grooves 220r may be open along the length of side-to-surface grooves 220r.

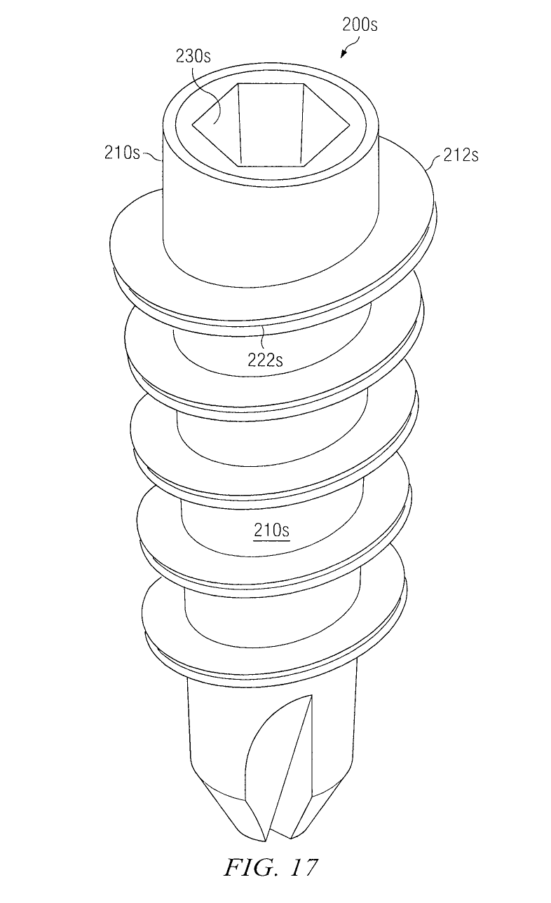

FIG. 17 shows a perspective view of a threaded bone screw according to several embodiments. FIG. 17 illustrates an embodiment of screw 200s featuring a self drilling/tapping end 205s, a cylindrical shank 210s, a thread 212s, edge grooves 222s cut into the edge of thread 212s, and internal metal connection to abutment 230s.

FIG. 18 shows a threaded bone screw 200t featuring a cylindrical shank 210t and oblique threads 212t. In FIGS. 8-17, the threads are illustrated as perpendicular to the cylindrical shank. However, the orientation of thread 212t is not limited to any particular angle. For example, FIG. 18 illustrates a thread 212t oriented relative to the center cylindrical shank 210t at an angle of less than 90 degrees.

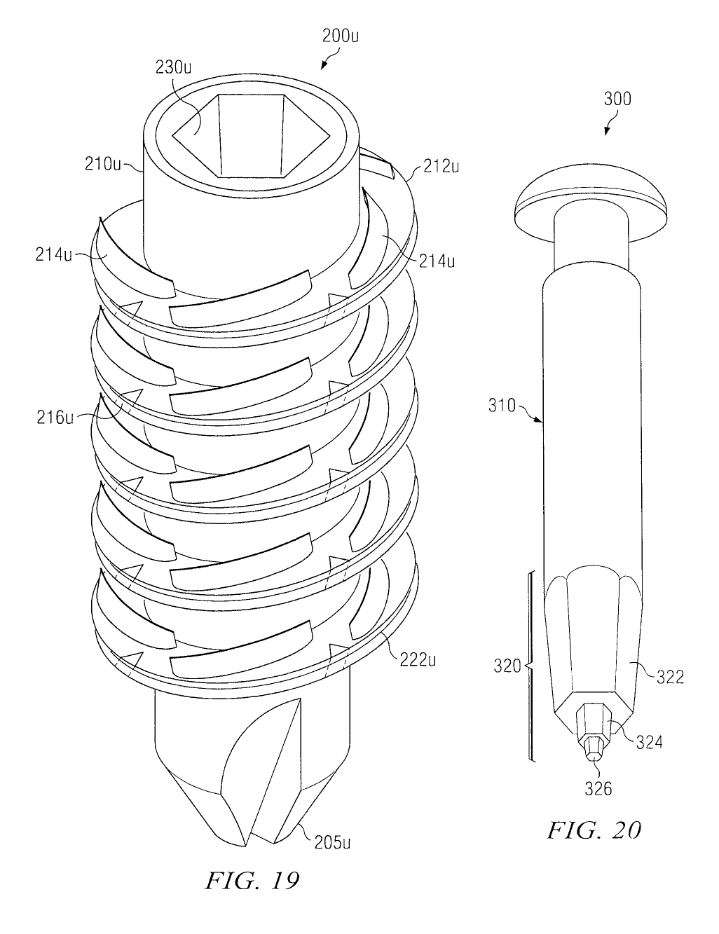

Any of the features shown by FIGS. 3 through 18 may be incorporated into various embodiments. For example, FIG. 19 shows a perspective view of a threaded bone screw incorporating elements from multiple embodiments. FIG. 19 features a screw 200u with a self drilling/tapping end 205u, center cylindrical shank 210u, thread 212u, ridges 214u, oblique grooves 216u, edge grooves 222u, and internal metal connection to abutment 230u. However, other embodiments may include a different combination of available features.

In some embodiments, the threads described in FIGS. 8-19 may be constructed from a metallic material, such as titanium. In other embodiments, threads may be cut into a non-metallic material, such as ceramic. In some embodiments, a dental implant may include both metallic and non-metallic threads. For example, a dental implant may include a metallic threaded portion with a ceramic neck/crown, but with a thread cut into the ceramic neck/crown such that the thread pattern continues from the metallic threaded portion. Teachings of certain embodiments also recognize that zirconia may be used in one or more threaded portions of a dental implant.

### Universal Implant Driver

Most dental implant systems include a variety of internal components and connections. For example, the dental implant 100 of FIG. 3 features the implant fixture 110, the implant abutment 130, and the crown 140. Typically, each of these components require a different driver tool. For example, implant fixture 110 and implant abutment 130 may have different-sized torquing devices. In addition, installation a dental implant such as dental implant 100 may require the pre-drilling of holes, such as pilot holes. Accordingly, teachings of certain embodiments recognize the use of a single universal implant driver sized to fasten multiple components of a dental implant.

FIG. 20 shows a universal implant driver 300 according to one embodiment. Implant driver 300 features a body 310 with one or more universal ends 320. For example, the dental implant driver 300 of FIG. 3 features three universal ends 320: an implant fixture driver 322, an implant abutment driver 324, and a healing cap driver 326. Implant fixture driver 322, implant abutment driver 324, and healing cap driver 326 are operable to drive in an implant fixture, an implant abutment, and a healing cap respectively. A healing cap is a device used during an intermediate stage of dental restoration. In some embodiments, a healing cap may allow gingival tissues to osseointegrate prior to placement of the permanent abutment or may help maintain proper spacing in the oral cavity before final restoration.

Implant fixture driver 322, implant abutment driver 324, and healing cap driver 326 are examples of the types of universal ends 320 that may be incorporated into universal implant driver 300. Other embodiments may include other universal ends 320 in addition to or in place of implant fixture driver 322, implant abutment driver 324, and healing cap driver 326. For example, a universal end 320 may be provided for the pre-drilling of holes, such as pilot holes. In addition, universal ends 320 such as implant fixture driver 322, implant abutment driver 324, and healing cap driver 326 are not limited to any particular geometry, but rather would reflect the geometry of the implant fixture, the implant abutment, and the healing cap. For example, these universal ends 320 may resemble a screw tip or bit, a socket head, a hex key, or any other particular driving devices.

In some embodiments, the universal ends 320 will be sized so that each end can engage a corresponding dental implant component. For example, in some embodiments, the universal ends 320 may resemble concentric hex keys, with the smaller hex keys protruding beyond the larger ones. In this type of embodiment, the universal ends 320 may be permanently fixed at an end of body 310. In other embodiments, the universal ends 320 may compress into the universal implant driver 300, stowing inside the body 310 when not in use. For example, the universal ends 320 may be spring loaded, such that the universal ends 320 compress into the body 310 when not in use. Yet other embodiments may include other arrangements for sizing the universal ends 320.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke 6 of 35 U.S.C. §112 as it exists on the date of filing hereof unless the words “means for” or “step for” are explicitly used in the particular claim.

What is claimed is:

1. A dental implant, comprising:
an implant fixture operable to secure the dental implant in bone;
am implant neck with a non-metallic finish surrounding the coronal end of the implant fixture;
an implant abutment attached to the implant fixture at the implant fixture's coronal end; and
a crown attached around the implant abutment and adjacent to the non-metallic neck.

2. The dental implant of claim 1, wherein the height of the implant neck along the coronal-apical axis is sized to fit between the top of the alveolar bone and the top of the surrounding gingiva in a tooth socket.

3. The dental implant of claim 1, wherein the height of the implant neck along the coronal-apical axis is shorter along the distal-mesial axis and taller along the lingual-facial axis.

4. The dental implant of claim 1, wherein the non-metallic neck is thinner along the distal-mesial axis and thicker along the lingual-facial axis.

5. The dental implant of claim 1, wherein the thickness of the implant neck is sized to match the shape of the crown.

6. The dental implant of claim 1, wherein the implant neck is comprised of a metal core and a ceramic finish.

7. The dental implant of claim 1, further comprising:
a plurality of ridges protruding from the exterior of the implant abutment; and
a plurality of corresponding grooves sized to receive the plurality of ridges and secure the implant abutment.

8. The dental implant of claim 1, wherein the non-metallic neck is 1.0 millimeter to 3.0 millimeters tall.

9. The dental implant of claim 1, wherein the crown is flush with the implant neck.

10. The dental implant of claim 1, wherein the implant fixture matches a real tooth shape selected from the group consisting of a molar tooth, a premolar tooth, a canine tooth, and a incisor tooth.

11. A screw for anchoring in bone comprising:
a central cylindrical shank with an inclined plane wrapped around the outside surface of the central cylindrical shank to form a helical thread; and
a plurality ridges formed on the surface of the inclined plane and extending outwards from the surface of the inclined plane.

12. The screw of claim 11, wherein the ridges start close to the edge of the inclined plane opposite the central cylindrical shank and move progressively closer to the central cylindrical shank.

13. The screw of claim 12, wherein the ridges are wider at the end opposite the central cylindrical shank and tapers towards a narrower end closer to the central cylindrical shank.

14. The screw of claim 12, wherein the ridges are taller at the end opposite the central cylindrical shank and tapers towards a shorter end closer to the central cylindrical shank.

15. The screw of claim 11, wherein the ridges are “V” or “U” shaped.

16. The screw of claim 11, wherein each ridge is oriented at an angle of 45 degrees to 135 degrees relative to the inclined plane.

17. The screw of claim 16, wherein each ridge is oriented away from the center cylindrical shank at an angle of 45 degrees to 60 degrees relative to the inclined plane.

18. The screw of claim 11, further comprising:
a plurality grooves formed in the outside edge of the inclined plane opposite the central cylindrical shank.

19. The screw of claim 18, wherein the grooves are “V” or “U” shaped.

20. The screw of claim 18, wherein the sides of the grooves are cut into the inclined plane at an angle of 30 degrees to 45 degrees relative to the tangent of the edge of the inclined plane.

21. The screw of claim 18, wherein the grooves are oriented in a direction so as to move bony fragments towards the central cylindrical shank.

22. The screw of claim 18, wherein the grooves are cut into the inclined plane at an angle of 45 degrees to 135 degrees relative to the surface of the inclined plane.

23. The screw of claim 18, further comprising side-to-surface grooves beginning near the grooves formed in the outside edge of the inclined plane opposite the central cylindrical shank and extending through the inclined plane towards the central cylindrical shank.

24. The screw of claim 11, further comprising a plurality of depressions in the surface of the inclined plane.

25. The screw of claim 24, wherein each depression is associated with a corresponding ridge.

26. The screw of claim 24, wherein the size and shape of each depression is similar to the size and shape of the corresponding ridge.

27. The screw of claim 24, wherein the depressions are sized to be a portion of the volume of the corresponding ridge.

28. The screw of claim 24, wherein two or more depressions form one or more crests between them.

29. The screw of claim 28, wherein the crests extend above the surface of the inclined plane.

30. The screw of claim 29, wherein the depressions spiral around the surface of the inclined plane towards the center cylindrical shank.

31. The screw of claim 30, wherein the depressions form a crest between them.

32. The screw of claim 31, wherein the crests extend above the surface of the inclined plane.

33. The screw of claim 11, further comprising an edge groove cut into the outside edge of the inclined plane opposite the central cylindrical shank and extending a portion of the length of the outside edge of the inclined plane opposite the central cylindrical shank.

34. The screw of claim 11, wherein the inclined plane is perpendicular to the central cylindrical shank.

35. The screw of claim 11, wherein the inclined plane is not perpendicular to the central cylindrical shank.

36. A screw for anchoring in bone comprising:
a central cylindrical shank with an inclined plane wrapped around the outside surface of the central cylindrical shank to form a helical thread; and
a plurality of grooves formed in the outside edge of the inclined plane opposite the central cylindrical shank.

37. The screw of claim 36, wherein the grooves are “V” or “U” shaped.

38. The screw of claim 36, wherein the sides of the grooves are cut into the inclined plane at an angle of 30 degrees to 45 degrees relative to the tangent of the edge of the inclined plane.

39. The screw of claim 36, wherein the grooves are oriented in a direction so as to move bony fragments towards the central cylindrical shank.

40. The screw of claim 36, wherein the grooves are cut into the inclined plane at an angle of 45 degrees to 135 degrees relative to the surface of the inclined plane.

41. The screw of claim 36, further comprising side-to-surface grooves beginning near the grooves formed in the outside edge of the inclined plane opposite the central cylindrical shank and extending through the inclined plane towards the central cylindrical shank.

42. The screw of claim 36, further comprising an edge groove cut into the outside edge of the inclined plane opposite the central cylindrical shank and extending a portion of the length of the outside edge of the inclined plane opposite the central cylindrical shank.

43. The screw of claim 36, further comprising a plurality of depressions in the surface of the inclined plane.

44. The screw of claim 36, wherein two or more depressions form one or more crests between them.

45. The screw of claim 44, wherein the crests extend above the surface of the inclined plane.

46. The screw of claim 43, wherein the depressions spiral around the surface of the inclined plane towards the center cylindrical shank.

47. The screw of claim 46, wherein the depressions form a crests between them.

48. The screw of claim 47, wherein the crests extend above the surface of the inclined plane.

49. The screw of claim 36, further comprising an edge groove cut into the outside edge of the inclined plane opposite the central cylindrical shank and extending a portion of the length of the outside edge of the inclined plane opposite the central cylindrical shank.

50. The screw of claim 36, wherein the inclined plane is perpendicular to the central cylindrical shank.

51. The screw of claim 36, wherein the inclined plane is not perpendicular to the central cylindrical shank.

52. A screw for anchoring in bone comprising:
a central cylindrical shank with an inclined plane wrapped around the outside surface of the central cylindrical shank to form a helical thread; and
a plurality of depressions in the surface of the inclined plane.

53. The screw of claim 52, wherein two or more depressions form one or more crests between them.

54. The screw of claim 53, wherein the crests extend above the surface of the inclined plane.

55. The screw of claim 52, wherein the depressions spiral around the surface of the inclined plane towards the center cylindrical shank.

56. The screw of claim 55, wherein the depressions form a crest between them.

57. The screw of claim 56, wherein the crests extend above the surface of the inclined plane.

58. The screw of claim 52, further comprising an edge groove cut into the outside edge of the inclined plane opposite the central cylindrical shank and extending a portion of the length of the outside edge of the inclined plane opposite the central cylindrical shank.

59. The screw of claim 52, wherein the inclined plane is perpendicular to the central cylindrical shank.

60. The screw of claim 52, wherein the inclined plane is not perpendicular to the central cylindrical shank.

61. A universal driver for installing a dental implant, comprising:
a body with a first end and a second end;
a handle attached to the first end; and
more than one universal end attached to the second end, the universal ends operable to drive one or more internal components of a dental implant.

62. The universal driver of claim 61, wherein at least one of the universal ends is operable to drive an implant fixture.

63. The universal driver of claim 61, wherein at least one of the universal ends is operable to drive an implant abutment.

64. The universal driver of claim 61, wherein at least one of the universal ends is operable to drive a healing cap.

65. The universal driver of claim 61, wherein the universal ends are stationary relative to the body.

66. The universal driver of claim 61, wherein the universal ends stow inside the body when not in use.
